(19) United States
(12) Patent Application Publication
(10) Pub. No.: US 2025/0101538 A1
(43) Pub. Date: Mar. 27, 2025

(54) Gas Injection Control System For Blast Furnace, And Control Method

(71) Applicant: XINJIANG BAYI IRON & STEEL CO., LTD., Urumqi (CN)

(72) Inventors: Derong Chen, Urumqi (CN); Baoshan Tian, Urumqi (CN); Jianxin Cai, Urumqi (CN); Lei Liu, Urumqi (CN); Tao Li, Urumqi (CN)

(21) Appl. No.: 18/728,634

(22) PCT Filed: Dec. 13, 2022
(86) PCT No.: PCT/CN2022/138699

§ 371 Date: Jul. 12, 2024

(30) Foreign Application Priority Data
Jan. 12, 2022 (CN) 202210034716.8

(51) Int. Cl. C21B 5/00; C21B 7/16; C21B 7/24

(52) U.S. Cl. CPC C21B 5/006; C21B 5/001; C21B 7/16; C21B 7/24; C21B 2005/005

(57) ABSTRACT

The present disclosure discloses a system and a method for controlling gas injection in blast furnace. The system for controlling gas injection in blast furnace includes a coke oven gas pipeline, a decarbonized gas pipeline, a protection nitrogen pipeline, and a main gas pipeline. The coke oven gas pipeline and the decarbonized gas pipeline are connected with the main gas pipeline, and distributing branch pipelines of main gas pipeline are located at nozzles of tuyeres of blast furnace. The protection nitrogen pipeline is connected to the main gas pipeline. A group of measuring components are used for each of the pipelines to detect operation status thereof. The system controls operation status of the pipelines by controlling pipelines with valves. The system and method may ensure that the system for injecting coke oven gas through tuyeres can stop running safely in abnormal situations.

### CROSS-REFERENCE TO RELATED DISCLOSURES

This disclosure claims priority to Chinese Patent Application No. 2022100347168, filed on Jan. 12, 2022, entitled “system and method for controlling gas injection in blast furnace”, which is hereby incorporated by reference in its entirety.

### TECHNICAL FIELD

The present disclosure relates to a technical field of gas injection in blast furnace, particularly relates to a system and method for controlling gas injection in blast furnace.

### BACKGROUND

As the CO₂ emissions by steel industry account for more than 15% of total emissions, steel enterprises will have significant pressure in reducing carbon emissions for a long time. At present, CO₂ contained in the gas for ironmaking accounts for about 70% of total CO₂ generated during the whole steel production. Therefore, the ironmaking is the focus in reducing CO₂ emissions in steel production. Blast furnaces in the art generally adopt a means of injecting coal through tuyeres, for an object of low-carbon and environmentally friendly smelting, which is included in the energy-saving and emission-reduction agenda of the steel industry. However, safety in operation becomes a main problem to be paid attention to a the process of injecting gas through tuyeres due to the flammability, explosiveness, and toxicity of gas.

### BRIEF SUMMARY

To address the above problems, the present disclosure provides a system and a method for controlling gas injection in blast furnace.

The following technical solutions are proposed in the present disclosure to address the above problems:
a system for controlling gas injection in blast furnace includes a coke oven gas pipeline, a decarbonized gas pipeline, a protection nitrogen pipeline, and a main gas pipeline. The coke oven gas pipeline and the decarbonized gas pipeline are connected with the main gas pipeline, and distributing branch pipelines of main gas pipeline are located at nozzles of tuyeres of blast furnace. The protection nitrogen pipeline is connected to the main gas pipeline. A group of measuring components are used for each of the pipelines to detect operation status thereof. The system automatically interlocks valve group based on feedback information from the detection points, to controle operation status of the pipelines to ensure safe and reliable operation of a system for injecting gas.

Furthermore, the coke oven gas pipeline is connected to a purifying and pressurizing system for coke oven gas. The gas is introduced into the purifying and pressurizing system to be supplied to the main gas pipeline by a compressor in the purifying and pressurizing system. A pressure control valve PV2101, a flow control valve FV2101, and a shut-off valve ZV2101 are sequentially provided on the coke oven gas pipeline connected to the main gas pipeline.

Further, temperature measuring component TE-0001, flow measuring component FT-0001, and pressure measuring component PT-0001 are installed on the coke oven gas pipeline in front of the purifying and pressurizing system for coke oven gas. The coke oven gas enters the compressor for coke oven gas to be compressed at a pressure above 0.7 MPa, after being purified by an adsorption tower to remove tar, benzene, naphthalene, and other impurities.

Further, a pressure measuring component PT-2102 is installed on a pipeline in front of the pressure control valve PV2101. A temperature measuring component TE-2101, a flow measuring component FT-2101, and a pressure measuring component PT-2101 are installed on a pipeline between the pressure control valve PV2101 and the flow control valve FV2101.

Further, the decarbonized gas with a pressure higher than 0.7 MPa is introduced into this system. A pressure control valve PV2201, a flow control valve FV2201, and a shut-off valve ZV2201 are sequentially installed on a pipeline connected to the main gas pipeline.

Further, a pressure measuring component PT-2202 is installed on the decarbonized gas pipeline at front of the pressure control valve PV2201. A temperature measuring component TE-2201, a flow measuring component FT-2201, and a pressure measuring component PT-2201 are installed between the pressure control valve PV2201 and the flow control valve FV2201.

Furthermore, the protection nitrogen pipeline includes a main nitrogen pipeline directly connected with the main gas pipeline, and an auxiliary nitrogen pipeline connected to pipelines before each nozzle.

Furthermore, the main nitrogen pipeline is sequentially provided with a flow control valve FV2301 and a shut-off valve ZV2301 from a part connected to the system. The auxiliary nitrogen pipeline is provided with a shut-off valve ZV3001 for control on-and-off of the pipeline, and each branch pipeline of the pipelines connected to the nozzles is provided with a shut-off valve to control on-and-off of the pipeline.

Furthermore, the main nitrogen pipeline is provided with a temperature measuring component TE-0002, a flow measuring component FT-0002, and a pressure measuring component PT-0002. A temperature measuring component TE-2301, a flow measuring component FT-2301, and a pressure measuring component PT-2301 are provided at a position in front of the flow control valve FV2301 and a pressure measuring component PT-0006 is provided at a position in front of the main gas pipeline. A pressure measuring component PT-0005 is provided at a position at back of a shut-off valve ZV3001 on the auxiliary nitrogen pipeline.

Furthermore, the main gas pipeline is provided with a flow measuring component FT and a pressure measuring component PT. Temperature measuring components, flow measuring components, and pressure measuring components are provided on branch pipelines connecting the main gas pipeline to each nozzle.

A method for controlling gas injection in blast furnace includes the following steps:
K1: transferring measuring signals from each measuring component and status signals of each device in the system to a central control component before injecting gas;
K2: determining, by the central control component, whether received signals indicate normal operation status;
K3: issuing, by the central control component, an injection signal to start a program for controlling gas injection;
K4: monitoring an operation status of each part of the system and operation statuses of all valves and the blast furnace in real-time during gas injection to determine whether operation data obtained by each measuring component is within a required range;
K5: issuing, by the central control component, a injection stop signal to run a program for stopping gas injection, so as to stop injecting gas into the furnace.

Furthermore, the starting a program in step of K3 includes the following steps:
Step 1: starting the program for controlling gas injection when the statuses of devices are normal;
Step 2: setting a preset opening for the flow control valve FV2301 on the protection nitrogen pipeline;
Step 3: opening the shut-off valve ZV2301 on the protection nitrogen pipeline;
Step 4: opening the flow control valve FV2301 on the protection nitrogen pipeline by a preset opening according to a set flow rate;
Step 5: opening the shut-off valve on the coke oven gas pipeline or the decarbonized gas pipeline after 120 seconds;
Step 6: opening the flow control valve on the coke oven gas pipeline or the decarbonized gas pipeline by an appropriate opening according to a set flow rate;
Step 7: opening the pressure control valve on the coke oven gas pipeline or the decarbonized gas pipeline by an opening greater than the opening under the set flow rate;
Step 8: shutting off the flow control valve FV2301 on the protection nitrogen pipeline within 60 seconds;
Step 9: shutting off the shut-off valve ZV2301 on the protection nitrogen pipeline, and starting injecting coke oven gas into the furnace.

Furthermore, the stop injecting gas into the furnace in step of K5 includes the following steps:
D1: opening the flow control valve FV2301 on the protection nitrogen pipeline at 100%;
D2: opening the shut-off valve ZV2301 on the protection nitrogen pipeline;
D3: shutting off the flow control valves on the coke oven gas pipeline or the decarbonized gas pipeline;
D4: shutting off the shut-off valves on the coke oven gas pipeline or the decarbonized gas pipeline;
D5: shutting off the flow control valve FV2301 on the protection nitrogen pipeline to allow the set flow rate;
D6: confirming that the shut-off valve ZV2301 on the protection nitrogen pipeline is fully opened;
D7: opening the shut-off valve ZV3001 on the auxiliary protection nitrogen pipeline;
D8: shutting off the flow control valve FV2301 on the protection nitrogen pipeline gradually.
D9: shutting off the shut-off valves on the nozzle branch pipelines;
D10: shutting off the shut-off valves on the branch pipelines connecting the auxiliary protection nitrogen pipeline to the nozzles after a while till gas inside the furnace is swept out by the nitrogen;
D11: shutting off the shut-off valve ZV3001 on the auxiliary protection nitrogen pipeline.

Furthermore, the gas injection program runs normally and keeps injecting gas into the furnace when all operation statuses monitored in step of K4 at each part of the system during the system is running are normal. The central control component immediately executes the program for stop gas injection to stop the gas supply, and injects nitrogen to protect the devices of the blast furnace.

Furthermore, nitrogen may be automatically supplemented into the system to maintain pressure and sweep the system, when there is decarbonized gas abnormality, coke oven gas compressor abnormal, or valve malfunctions leading to insufficient pressure or stopping of gas supply, so as to avoid backflow in the gas supply system.

Furthermore, nitrogen may be automatically be supplemented into the system to maintain pressure and purge the system, when there are anomalies such as abnormal pressure of hot air in blast furnace, abnormal pressure of cold air in blast furnace, abnormal pressure of water at branches in the blast furnace, abnormal pressure of soft water at outlets, abnormal pressure at outlets of turbid oil pump, the pressure difference between the gas surrounding pipe and hot air being out of a normal range, abnormal pressure in main nitrogen pipeline in the protection nitrogen pipeline, or the total flow of decarbonized gas and coke oven gas being less than a preset value.

The present disclosure discloses a safe and efficient method for controlling injection of gas at tuyeres against both normal and abnormal operations after gas is injected through tuyeres. The method disclosed by the present disclosure may ensure that the system can operate normally after gas is injected through tuyeres and operation can be safely stopped under abnormal conditions, so as to ensure system safety, achieve a safe interlocking of individual valves and valve groups in the system for injecting gas through tuyeres, and ensure long-term stable operation of the system for injecting gas through tuyeres to save energy, reduce carbon emissions.

### BRIEF DESCRIPTION OF THE DRAWINGS

Detailed description of the present disclosure would be made below with FIGs. and embodiments.

FIG. 1 is a schematic view of the system for controlling gas injection in blast furnace of the present disclosure.

FIG. 2 is a flowchart of the program for starting injection of coke oven gas according to the present disclosure.

FIG. 3 is a flowchart of the program for stopping injection of coke oven gas according to the present disclosure.

FIG. 4 is a flowchart of the program for starting injection of decarbonized gas according to the present disclosure.

FIG. 5 is a flowchart of the program for stopping injection of decarbonized gas according to the present disclosure.

### DETAILED DESCRIPTION

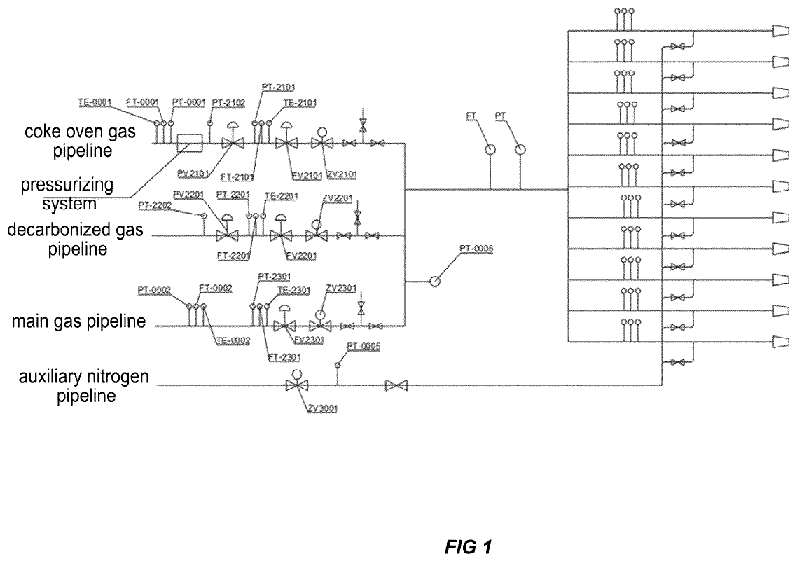

As shown in FIG. 1, a system for injecting gas into blast furnace may include includes a coke oven gas pipeline, a decarbonized gas pipeline, and a protection nitrogen pipeline.

The coke oven gas pipeline and the decarbonized gas pipeline are connected with the main gas pipeline, and are distributed to nozzles of tuyeres of blast furnace by a main gas pipeline so that the gas is injected into the blast furnace through the nozzles.

The protection nitrogen pipeline has two branch lines, one of which is connected to the main gas pipeline together with the coke oven gas pipeline and the decarbonized gas pipeline so that the protection nitrogen enters the main gas pipeline with the coke oven gas and the decarbonized gas and distributed to the nozzles by the main gas pipeline to be injected into the blast furnace.

The protection nitrogen pipeline has a main nitrogen pipeline directly connected to the main gas pipeline and an auxiliary nitrogen pipeline connected to pipelines before each nozzle to control the nitrogen pipeline by valves.

The coke oven gas is introduced into the purifying and pressurizing system for coke oven gas after being introduced into the system, and then gas is introduced into the system by a compressor in a pressurizing system, and then supplied to the main gas pipeline. The coke oven gas pipeline is provided with a pressure control valve PV2101, a flow control valve FV2101, and a shut-off valve ZV2101 before the main gas pipeline, and a relief pipe at back of the shut-off valve to perform swiping to balance the pressure, and the relief pipe is controlled by the shut-off valve.

The coke oven gas pipeline is provided with a temperature measuring component TE-0001, a flow measuring component FT-0001, and a pressure measuring component PT-0001 in front of the purifying and pressurizing system for coke oven gas.

Aa pressure measuring component PT-2102 is provided on a pipeline in front of the pressure control valve PV2101. A temperature measuring component TE-2101, a flow measuring component FT-2101, and a pressure measuring component PT-2101 are installed on a pipeline between the pressure control valve PV2101 and the flow control valve FV2101.

The decarbonized gas is introduced into this system by a compressor, and a pressure control valve PV2201, a flow control valve FV2201, and a shut-off valve ZV2201 are sequentially installed on a pipeline connected to the main gas pipeline.

A pressure measuring component PT-2202 is installed on the decarbonized gas pipeline at front of the pressure control valve PV2201. A temperature measuring component TE-2201, a flow measuring component FT-2201, and a pressure measuring component PT-2201 are installed between the pressure control valve PV2201 and the flow control valve FV2201.

The main nitrogen pipeline of the protection nitrogen pipeline is sequentially provided with a flow control valve FV2301 and a shut-off valve ZV2301 before a position where the pipeline is connected to the system, and a relief pipe at back of the shut-off valve, which is controlled by the shut-off valve. The auxiliary nitrogen pipeline is provided with a shut-off valve ZV3001 for control on-and-off of the pipeline before a position where the pipeline is connected to the system, and each branch pipeline of the pipelines connected to the nozzles is provided with a shut-off valve to control on-and-off of the branch pipeline.

The main nitrogen pipeline is provided with a temperature measuring component TE-0002, a flow measuring component FT-0002, and a pressure measuring component PT-0002. A temperature measuring component TE-2301, a flow measuring component FT-2301, and a pressure measuring component PT-2301 are provided at a position in front of the flow control valve FV2301 and a pressure measuring component PT-0006 is provided at a position in front of the main gas pipeline and after the flow control valve FV2301. A pressure measuring component PT-0005 is provided at a position at back of a shut-off valve ZV3001 on the pipeline connected to the nozzles.

The main gas pipeline is provided with a flow measuring component FT and a pressure measuring component PT to detect the operation status in the main gas pipeline in a case that the coke oven gas pipeline and the decarbonized gas pipeline are connected with the main gas pipeline.

Temperature measuring components, flow measuring components, and pressure measuring components are provided on branch pipelines connecting the main gas pipeline to each nozzle to detect the operation status of each branch pipeline.

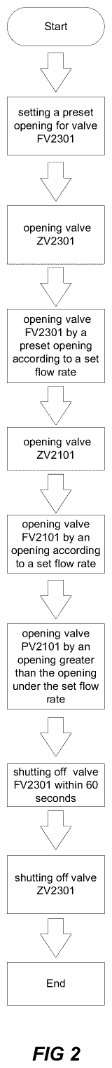

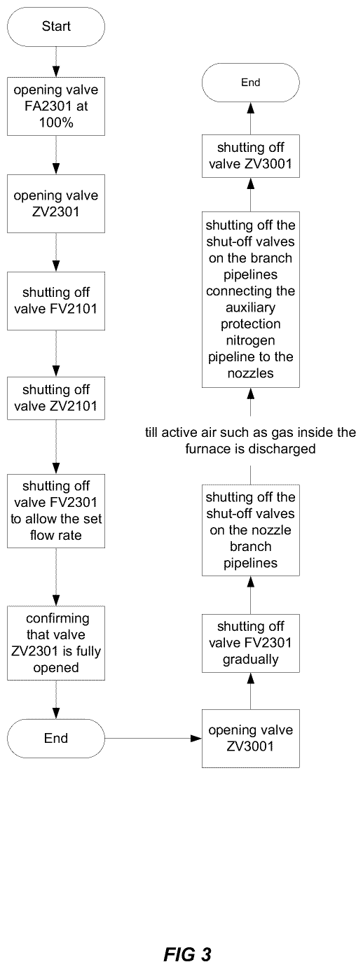

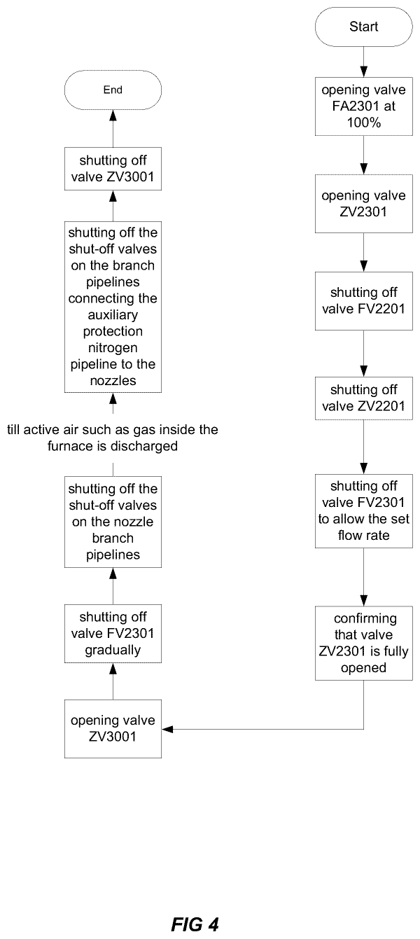

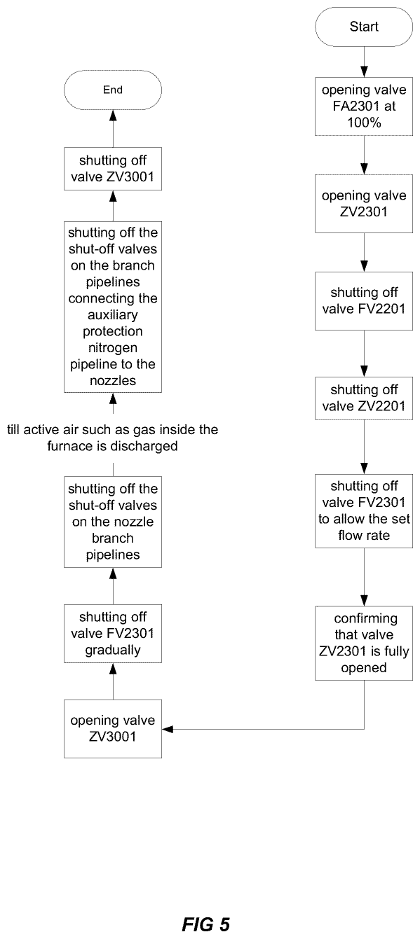

A method for controlling gas injection in blast furnace includes the steps as shown in FIGS. 2-5:

### 1. Injecting Coke Oven Gas

Starting;

Detecting data by each measuring component on the coke oven gas pipeline, and transferring data signals to a central control component;

Issuing, by the central control component, an injection signal to start injection of coke oven gas when the following operation statuses are determined to be normal:
operation statuses of the blast furnace are normal, for example, a blower of the blast furnace runs normally, a pressure of hot air in the blast furnace is normal, a pressure of cold air in blast furnace is normal, a pressure and a flow of water at tuyeres in the blast furnace are normal, a pressure and a flow of soft water at outlets of the blast furnace is normal, a pressure and a flow of turbid water are normal;
operation statuses of the coke oven gas pipeline are normal, for example, a compressor on the coke oven gas pipeline runs normally, a pressure at inlet and outlet of the compressor are normal, a pressure at inlet of the pressure control valve is normal, the pressure control valve runs normally, a flow of the pressure control valve is under normal control, and the shut-off valve runs normally;
a pressure at inlet of the pressure control valve on the protection nitrogen pipeline is normal, and the flow control valve and the quick open valve run normally.

The running of the system for controlling coke oven gas injection includes the following steps:
S1: setting a preset opening for the flow control valve FV2301 on the protection nitrogen pipeline;
S2: opening the shut-off valve ZV2301 on the protection nitrogen pipeline;
S3: opening the flow control valve FV2301 on the protection nitrogen pipeline by a preset opening according to a set flow rate;
S4: opening the shut-off valve ZV2101 on the coke oven gas pipeline
S5: opening the flow control valve FV2101 on the coke oven gas pipeline by an appropriate opening according to a set flow rate;
S6: opening the pressure control valve PV2101 on the coke oven gas pipeline by an opening greater than the opening under the set flow rate;
S7: shutting off the flow control valve FV2301 on the protection nitrogen pipeline within 60 seconds;
S8: shutting off the shut-off valve ZV2301 on the protection nitrogen pipeline; Stopping;

When the operation of the furnace is stopping when the work is done, stopping gas supplyment, which includes the following steps:
D1: opening the flow control valve FV2301 on the protection nitrogen pipeline at 100%;
D2: opening the shut-off valve ZV2301 on the protection nitrogen pipeline;
D3: shutting off the flow control valve FV2101 on the coke oven gas pipeline;
D4: shutting off the shut-off valve ZV2101 on the coke oven gas pipeline;
D5: shutting off the flow control valve FV2301 on the protection nitrogen pipeline to allow the set flow rate;
D6: confirming that the shut-off valve ZV2301 on the protection nitrogen pipeline is fully opened;
D7: opening the shut-off valve ZV3001 on the auxiliary protection nitrogen pipeline;
D8: shutting off the flow control valve FV2301 on the protection nitrogen pipeline gradually.
D9: shutting off the shut-off valves on the nozzle branch pipelines;
D10: shutting off the shut-off valves on the branch pipelines connecting the auxiliary protection nitrogen pipeline to the nozzles after a while till active air such as gas inside the furnace is discharged by the nitrogen;
D11: shutting off the shut-off valve ZV3001 on the auxiliary protection nitrogen pipeline.

Running:
supplying coke oven gas normally when the following operation statuses are within normal range: a pressure of hot air in the blast furnace, a pressure of cold air in blast furnace, a pressure and a flow of water at tuyeres in the blast furnace, a pressure and a flow of soft water at outlets of the blast furnace, a pressure and a flow of turbid water;
running of compressor on the coke oven gas pipeline, a pressure at inlet and outlet of the compressor, a pressure at inlet of the pressure control valve, running of the pressure control valve, a control of flow of the pressure control valve, and running of shut-off valve, and running a program for stopping supplyment of coke oven gas to stop supply coke oven gas and inject protection nitrogen to protect devices again incidents when any one of the above operation statuses is out of normal range, i.e., is abnormal.
running a program for stopping the system, when there are anomalies such as abnormal pressure of hot air in blast furnace, abnormal pressure of cold air in blast furnace, abnormal pressure of water at branches in the blast furnace, abnormal pressure of soft water at outlets, abnormal pressure at outlets of turbid oil pump, the pressure difference between the gas surrounding pipe and hot air being out of a normal range, abnormal pressure in main nitrogen pipeline or the protection nitrogen pipeline, or the total flow of decarbonized gas and coke oven gas being less than a preset value.

### 2. Injecting Decarbonized Gas

Detecting data by each measuring component on the decarbonized gas pipeline, and transferring data signals to a central control component;

Issuing, by the central control component, an injection signal to start injection of decarbonized gas and run a system for controlling injection of coke oven gas, when the following operation statuses are determined to be normal:
operation statuses of the blast furnace are normal, for example, a blower of the blast furnace runs normally, a pressure of hot air in the blast furnace is normal, a pressure of cold air in blast furnace is normal, a pressure and a flow of water at tuyeres in the blast furnace are normal, a pressure and a flow of soft water at outlets of the blast furnace is normal, a pressure and a flow of turbid water are normal;
operation statuses of the decarbonized gas pipeline and open-hearth furnace are normal, for example, a compressor on the decarbonized gas pipeline runs normally, a pressure at inlet and outlet of the compressor are normal, a pressure at inlet of the pressure control valve is normal, the pressure control valve runs normally, a flow of the pressure control valve is under normal control, and the shut-off valve runs normally;
a difference between a pressure at the back of adjusting valve of decarbonized gas pipeline and a pressure of hot air is within a normal range, a difference between a pressure of a gas surrounding pipe and a pressure of hot air;
a pressure at inlet of the pressure control valve on the protection nitrogen pipeline is normal, and the flow control valve and the quick open valve run normally.

The running of the system for controlling coke oven gas injection includes the following steps:
C1: setting a preset opening for the flow control valve FV2301 on the protection nitrogen pipeline;
C2: opening the shut-off valve ZV2301 on the protection nitrogen pipeline;
C3: opening the flow control valve FV2301 on the protection nitrogen pipeline by a preset opening according to a set flow rate;
C4: opening the shut-off valve ZV2201 on the decarbonized gas pipeline
C5: opening the flow control valve FV2201 on the decarbonized gas pipeline by an appropriate opening according to a set flow rate;
C6: opening the pressure control valve PV2201 on the decarbonized gas pipeline by an opening greater than the opening under the set flow rate;
C7: shutting off the flow control valve FV2301 on the protection nitrogen pipeline within 60 seconds;
C8: shutting off the shut-off valve ZV2301 on the protection nitrogen pipeline;

When stopping decarbonized gas supplyment, the stopping includes the following steps:
D1: opening the flow control valve FV2301 on the protection nitrogen pipeline at 100%;
D2: opening the shut-off valve ZV2301 on the protection nitrogen pipeline;
D3: shutting off the flow control valves FV2201 on the decarbonized gas pipeline;
D4: shutting off the shut-off valves ZV2201 on the decarbonized gas pipeline;
D5: shutting off the flow control valve FV2301 on the protection nitrogen pipeline to allow the set flow rate;
D6: confirming that the shut-off valve ZV2301 on the protection nitrogen pipeline is fully opened;
D7: opening the shut-off valve ZV3001 on the auxiliary protection nitrogen pipeline;
D8: shutting off the flow control valve FV2301 on the protection nitrogen pipeline gradually.
D9: shutting off the shut-off valves on the nozzle branch pipelines;
D10: shutting off the shut-off valves on the branch pipelines connecting the auxiliary protection nitrogen pipeline to the nozzles after a while till active air such as gas inside the furnace is discharged by the nitrogen;
D11: shutting off the shut-off valve ZV3001 on the auxiliary protection nitrogen pipeline.

Running:
supplying decarbonized gas normally when the following operation statuses are within normal range: running of a blower of the blast furnace, a pressure of hot air in the blast furnace, a pressure of cold air in blast furnace, a pressure and a flow of water at tuyeres in the blast furnace, a pressure and a flow of soft water at outlets of the blast furnace, a pressure and a flow of turbid water;
operation statuses of the decarbonized gas pipeline such as running of compressor on the decarbonized gas pipeline, a pressure at inlet and outlet of the compressor, a pressure at inlet of the pressure control valve, running of the pressure control valve, a control of flow of the pressure control valve, and running of shut-off valve, and operation status of open-hearth furnace;
a difference between a pressure at the back of adjusting valve of decarbonized gas pipeline and a pressure of hot air is within a normal range, a difference between a pressure of a gas surrounding pipe and a pressure of hot air;
a pressure at inlet of the pressure control valve on the protection nitrogen pipeline is normal, and the flow control valve and the quick open valve run normally, and
running a program for stopping supplyment of decarbonized gas to stop supply decarbonized gas and inject protection nitrogen to protect devices again incidents when any one of the above operation statuses is out of normal range, i.e., is abnormal,
running a program for stopping the system, when there are anomalies such as abnormal pressure of hot air in blast furnace, abnormal pressure of cold air in blast furnace, abnormal pressure of water at branches in the blast furnace, abnormal pressure of soft water at outlets, abnormal pressure at outlets of turbid oil pump, the pressure difference between the gas surrounding pipe and hot air being out of a normal range, abnormal pressure in main nitrogen pipeline or the protection nitrogen pipeline, or the total flow of decarbonized gas and decarbonized gas being less than a preset value.

The present disclosure discloses a safe and efficient method for controlling injection of gas at tuyeres against both normal and abnormal operations after gas is injected through tuyeres. The method disclosed by the present disclosure may ensure that the system can operate normally after gas is injected through tuyeres and operation can be safely stopped under abnormal conditions, so as to ensure system safety, achieve a safe interlocking of individual valves and valve groups in the system for injecting gas through tuyeres, and ensure long-term stable operation of the system for injecting gas through tuyeres to save energy, reduce carbon emissions.

1. A system for controlling gas injection in a blast furnace, comprising: a coke oven gas pipeline, a decarbonized gas pipeline, a protection nitrogen pipeline, and a main gas pipeline, wherein:
the coke oven gas pipeline and the decarbonized gas pipeline are connected with the main gas pipeline, distributing branch pipelines of main gas pipeline are located at nozzles of tuyeres of blast furnace, the protection nitrogen pipeline is connected to the main gas pipeline, a group of measuring components are used for each of the pipelines to detect operation status thereof, and the system automatically interlocks a valve group based on feedback information from detection points to control an operation status of the pipelines to ensure safe and reliable operation of a system for injecting gas;
the coke oven gas pipeline is connected to a purifying and pressurizing system for coke oven gas, the gas is introduced into the a purifying and pressurizing system to be supplied to the main gas pipeline by a compressor in the purifying and pressurizing system, a pressure control valve PV2101, a flow control valve FV2101, and a shut-off valve ZV2101 are sequentially provided on the coke oven gas pipeline connected to the main gas pipeline;
a temperature measuring component TE-0001, a flow measuring component FT-0001, and a pressure measuring component PT-0001 are installed on the coke oven gas pipeline in front of the purifying and pressurizing system for coke oven gas, and the coke oven gas enters the compressor for coke oven gas to be compressed at a pressure above 0.7 MPa, after being purified by an adsorption tower to remove tar, benzene, naphthalene, and other impurities;
a pressure measuring component PT-2102 is installed on a pipeline in front of the pressure control valve PV2101, and a temperature measuring component TE-2101, a flow measuring component FT-2101, and a pressure measuring component PT-2101 are installed on a pipeline between the pressure control valve PV2101 and the flow control valve FV2101;
the decarbonized gas with a pressure higher than 0.7 MPa is introduced into the system, and a pressure control valve PV2201, a flow control valve FV2201, and a shut-off valve ZV2201 are sequentially installed on a pipeline connected to the main gas pipeline; and
a pressure measuring component PT-2202 is installed on the decarbonized gas pipeline at front of the pressure control valve PV2201, and a temperature measuring component TE-2201, a flow measuring component FT-2201, and a pressure measuring component PT-2201 are installed between the pressure control valve PV2201 and the flow control valve FV2201.

2. The system of claim 1, wherein the protection nitrogen pipeline comprises a main nitrogen pipeline directly connected with the main gas pipeline and an auxiliary nitrogen pipeline connected to pipelines before each nozzle.

3. The system of claim 2, wherein the main nitrogen pipeline is sequentially provided with a flow control valve FV2301 and a shut-off valve ZV2301 from a part connected to the system, the auxiliary nitrogen pipeline is provided with a shut-off valve ZV3001 for controlling on-and-off of the pipeline, and each branch pipeline of the pipelines connected to the nozzles is provided with a shut-off valve to control on-and-off of the pipeline.

4. The system of claim 2, wherein:
the main nitrogen pipeline is provided with a temperature measuring component TE-0002, a flow measuring component FT-0002, and a pressure measuring component PT-0002;
a temperature measuring component TE-2301, a flow measuring component FT-2301, and a pressure measuring component PT-2301 are provided at a position in front of the flow control valve FV2301;
a pressure measuring component PT-0006 is provided at a position in front of the main gas pipeline; and
a pressure measuring component PT-0005 is provided at a position at back of a shut-off valve ZV3001 on the auxiliary nitrogen pipeline.

5. The system of claim 1, wherein the main gas pipeline is provided with a flow measuring component FT and a pressure measuring component PT, and temperature measuring components, flow measuring components, and pressure measuring components are provided on branch pipelines connecting the main gas pipeline to each nozzle.

6. A method for controlling the gas injection in the blast furnace of claim 3, comprising the following steps:
K1: transferring measuring signals from each measuring component and status signals of each device in the system to a central control component before injecting gas;
K2: determining, by the central control component, whether received signals indicate normal operation status;
K3: issuing, by the central control component, an injection signal to start a program for controlling gas injection;
K4: monitoring an operation status of each part and end operation statuses of all valves and the blast furnace in real-time during gas injection to determine whether operation data obtained by each measuring component is within a required range; and
K5: issuing, by the central control component, an injection stop signal to run a program for stopping gas injection, so as to stop injecting gas into the blast furnace,
wherein the program runs normally and keeps injecting gas into the blast furnace when all operation statuses monitored in K4 at each part of the system when the system is running are normal, and the central control component immediately executes the program for stopping gas injection to stop a gas supply and injects nitrogen to protect the blast furnace.

7. The method of claim 6, wherein the starting a program in K3 comprises the following steps:
Step 1: starting the program for controlling gas injection when the statuses are normal;
Step 2: setting a preset opening for the flow control valve FV2301 on the protection nitrogen pipeline;
Step 3: opening the shut-off valve ZV2301 on the protection nitrogen pipeline;
Step 4: opening the flow control valve FV2301 on the protection nitrogen pipeline by a preset opening according to a set flow rate;
Step 5: opening the shut-off valve on the coke oven gas pipeline or the decarbonized gas pipeline after 120 seconds;
Step 6: opening the flow control valve on the coke oven gas pipeline or the decarbonized gas pipeline by an appropriate opening according to the set flow rate;
Step 7: opening the pressure control valve on the coke oven gas pipeline or the decarbonized gas pipeline by an opening greater than the opening under the set flow rate;
Step 8: shutting off the flow control valve FV2301 on the protection nitrogen pipeline within 60 seconds; and
Step 9: shutting off the shut-off valve ZV2301 on the protection nitrogen pipeline and starting injecting coke oven gas into the furnace.

8. The method of claim 7, wherein the stop injecting gas into the blast furnace in K5 comprises the following steps:
D1: opening the flow control valve FV2301 on the protection nitrogen pipeline at 100%;
D2: opening the shut-off valve ZV2301 on the protection nitrogen pipeline;
D3: shutting off the flow control valves on the coke oven gas pipeline or the decarbonized gas pipeline;
D4: shutting off the shut-off valves on the coke oven gas pipeline or the decarbonized gas pipeline;
D5: shutting off the flow control valve FV2301 on the protection nitrogen pipeline to allow the set flow rate;
D6: confirming that the shut-off valve ZV2301 on the protection nitrogen pipeline is fully opened;
D7: opening the shut-off valve ZV3001 on the auxiliary nitrogen pipeline;
D8: shutting off the flow control valve FV2301 on the protection nitrogen pipeline gradually;
D9: shutting off the shut-off valves on the nozzle-branch pipelines;
D10: shutting off the shut-off valves on the branch pipelines connecting the auxiliary nitrogen pipeline to the nozzles after a while till gas inside the furnace is swept out by the nitrogen; and
D11: shutting off the shut-off valve ZV3001 on the auxiliary nitrogen pipeline.

9. The method of claim 6, wherein nitrogen is automatically supplied into the system to maintain pressure and sweep the system when there is decarbonized gas abnormality, coke oven gas compressor abnormality, or valve malfunctions leading to insufficient pressure or stopping of gas supply, so as to avoid backflow in a gas supply system.

10. The method of claim 6, wherein nitrogen is automatically supplied into the system to maintain pressure and purge the system when there are anomalies such as: abnormal pressure of hot air in blast furnace, abnormal pressure of cold air in blast furnace, abnormal pressure of water at branches in the blast furnace, abnormal pressure of soft water at outlets, abnormal pressure at outlets of turbid oil pump, a pressure difference between the gas surrounding pipe and hot air being out of a normal range, abnormal pressure in main nitrogen pipeline in the protection nitrogen pipeline, or a total flow of decarbonized gas and coke oven gas being less than a preset value.
